(19) United States
(12) Patent Application Publication
(10) Pub. No.: US 2024/0234877 A1
(43) Pub. Date: Jul. 11, 2024

(54) HOUSING ASSEMBLY WITH REINFORCING STRUCTURE AND BUTTON BATTERY

(71) Applicant: DONGGUAN LIWINON ELECTRONIC TECHNOLOGY CO., LTD, DONGGUAN (CN)

(72) Inventors: CHUANBAO WANG, DONGGUAN (CN); JIE CHEN, DONGGUAN (CN); SHAN YANG, DONGGUAN (CN)

(21) Appl. No.: 18/616,084

(22) Filed: Mar. 25, 2024

Related U.S. Application Data
(63) Continuation of application No. PCT/CN2022/087078, filed on Apr. 15, 2022.

(30) Foreign Application Priority Data
Sep. 28, 2021 (CN) 202122357278.2

(51) Int. Cl. H01M 50/109; H01M 50/119; H01M 50/124; H01M 50/181; H01M 50/627

(52) U.S. Cl. CPC H01M 50/109; H01M 50/119; H01M 50/1243; H01M 50/181; H01M 50/627

(57) ABSTRACT

A housing assembly with a reinforcing structure and a button battery are provided. The housing assembly includes a housing, an electrical connection member, an insulating member configured for fixedly connecting the electrical connection member with the housing and arranged inside or outside the housing, and a reinforcing member fixedly connected with the housing through the insulating member. The housing includes a first housing and a second housing, one of which is defined with a through hole. A projection of the electrical connection member is located within the through hole, and the reinforcing member is partially projected into the through hole. By providing the reinforcing member on the insulating member, a problem of insufficient structural strength of a composite structure composed of the housing and the electrical connection member is solved, sealing between the housing and the electrical connection member is enhanced, and energy density of the battery is improved.

### TECHNICAL FIELD

The present disclosure relates to the field of lithium ion battery manufacturing, in particular to a housing assembly with a reinforcing structure and a button battery.

### BACKGROUND

Sealing between a post and a cover plate is commonly in a manner similar to riveting, in which a plastic sealing ring is adopted between the post and the cover plate. The post and the cover plate are sealed by pressing the post and deforming the sealing ring, which is, however, with the following shortcomings: 1) less reliability, with a risk of liquid leakage; 2) large space occupied by the post in the height direction, increasing a thickness of the battery and causing loss of energy density.

In order to solve above problems, in related art, the post of metal rivet is replaced by a post of metal sheet, and the post and cover plate are sealed by hot pressing and compounding. In this design, because of a thinner post and a thinner cover plate with no enough structural strength, it is prone to cause deformation of a battery, and even liquid leakage of the battery.

### SUMMARY

In view of problems existing in background art, the present disclosure provides a housing assembly with a reinforcing structure and a button battery, which aims to solve a problem of insufficient structural strength of a composite structure of a housing and an electrical connection member, improve sealing of the housing and the electrical connection member, and also effectively improve energy density of a battery.

In order to achieve the above object, the present disclosure adopts following technical schemes.

A housing assembly with a reinforcing structure is provided in the present disclosure, which includes:
a housing including a first housing and a second housing, the second housing including a bottom wall and a side wall arranged at an edge of the bottom wall and extending upwards, the first housing covering an opening of the second housing, and the first housing or the second housing being defined with a through hole;
an electrical connection member, a projection of the electrical connection member being located within the through hole, the electrical connection member being at least partially embedded in the through hole;
an insulating member configured for fixedly connecting the electrical connection member with the housing, the insulating member being arranged inside or outside the housing; and
a reinforcing member partially projected into the through hole and fixedly connected with the housing through the insulating member.

Further, the reinforcing member is defined with an opening, and the opening is located in a projection surface of the through hole in an axial direction.

Further, the reinforcing member is an annular structure subjected to surface insulation treatment.

Further, the electrical connection member is provided with a protrusion, a size of the protrusion is smaller than a size of the opening in a radial direction, and a thickness of the protrusion is larger than a depth of the opening in the axial direction.

Further, the electrical connection member is accommodated in the through hole, allowing an annular gap to be defined in the through hole, and the annular gap is filled with an insulating material.

Further, the second housing is provided with a first protrusion protruding from an opening plane, the first protrusion and the opening plane define a positioning groove, and the first housing is embedded in the positioning groove.

Further, the housing is defined with a liquid injection hole and/or an explosion-proof sculpture.

Further, an inner surface of the housing is provided with an insulating layer.

A button battery is further provided in the present disclosure, which includes a battery cell and the housing assembly with the reinforcing structure according to any one of schemes described above for accommodating the battery cell.

The present disclosure has following beneficial effects.

In related art, in order to reduce a thickness of the battery, thicknesses of the electrical connection member and the housing are reduced, which results in insufficient structural strength of a composite structure composed of the electrical connection member and the housing through the insulating member, and may cause deformation and even liquid leakage of the battery. In this disclosure, the structural strength of the composite structure is increased by fixedly connecting the reinforcing member on the insulating member, and further, the reinforcing member can prevent the insulating member from being corroded by electrolyte, so that the composite structure is firmer and service life of the battery is prolonged.

### BRIEF DESCRIPTION OF THE DRAWINGS

FIG. 1 is a schematic sectional view of a button battery according to Embodiment 1 of the present disclosure;

FIG. 2 is a schematic sectional view of a housing assembly according to Embodiment 1 of the present disclosure;

FIG. 3 is an enlarged view of a welding part between a first housing and a second housing according to Embodiment 1 of the present disclosure;

FIG. 4 is a schematic sectional view of a reinforcing structure according to Embodiment 1 of the present disclosure;

FIG. 5 is a schematic sectional view of a battery cell according to Embodiment 1 of the present disclosure;

FIG. 6 is another schematic sectional view of the battery cell according to Embodiment 1 of the present disclosure;

FIG. 7 is a schematic sectional view of a housing assembly according to Embodiment 2 of the present disclosure;

FIG. 8 is a schematic sectional view of a housing assembly according to Embodiment 3 of the present disclosure;

FIG. 9 is a schematic sectional view of a reinforcing structure according to Embodiment 3 of the present disclosure;

FIG. 10 is a schematic sectional view of a housing assembly according to Embodiment 4 of the present disclosure;

FIG. 11 is a schematic sectional view of a housing assembly according to Embodiment 5 of the present disclosure;

FIG. 12 is a schematic sectional view of a housing assembly according to Embodiment 6 of the present disclosure;

FIG. 13 is a schematic sectional view of a housing assembly according to Embodiment 7 of the present disclosure;

FIG. 14 is a schematic sectional view of a housing assembly according to Embodiment 8 of the present disclosure; and

FIG. 15 is a schematic sectional view of a housing assembly according to Embodiment 9 of the present disclosure.

Reference numbers: 10—Button Battery; 100—Housing; 11—First Housing; 12—Second Housing; 121—First protrusion; 122—Opening Plane; 123—Positioning Groove; 101—through hole; 13—Electrical Connection Member; 131—protrusion; 14—Insulating Member; 141—Through Hole; 15—Reinforcing Member; 151—Opening; 102—Liquid Injection Hole; 103—Explosion-proof Sculpture; 104—Sealing Plug; 20—Battery Cell; 21—First Electrode Plate; 22—Second Electrode Plate; 23—Separator; 24—First Tab; 25—Second Tab; 26—Connector; X—Radial Direction; Y—Axial Direction.

### DETAILED DESCRIPTION OF THE EMBODIMENTS

In order to make the purposes, technical schemes and advantages of embodiments of this disclosure more clear, the technical schemes in the embodiments of this disclosure will be described clearly and completely with reference to the drawings in the embodiments of this disclosure; and it is Obvious that the described embodiments are part of the embodiments of this disclosure, but not all of them. On a basis of the embodiments in this disclosure, all other embodiments obtained by the ordinary skilled in the art without any creative effort are within the protection scope of this disclosure.

Unless otherwise defined, all technical and scientific terms used herein have same meaning as commonly understood by those skilled in the art of this disclosure. Terminology used in specification of the present disclosure herein is only for a purpose of describing specific embodiments, and is not intended to limit the disclosure. Terms “including” and “having” in the specification and claims of the present disclosure and description of above drawings, as well as any variations thereof, are intended to cover non-exclusive inclusion. Terms “first” and “second” in the specification and claims of this disclosure or the above drawings are used to distinguish different objects, not to describe a specific order or primary-secondary relationship.

Reference to “embodiment” herein means that a particular feature, structure or characteristic described in combination with the embodiment can be included in at least one of embodiments of the present disclosure. Occurence of this phrase in various parts in the specification does not necessarily refer to a same embodiment, nor is it an independent or alternative embodiment mutually exclusive with other embodiments. It is understood explicitly and implicitly by those skilled in the art that the embodiments described herein can be combined with other embodiments.

A term “and/or” herein is only a kind of relationship describing related objects, which means that there can be three kinds of relationships. For example, A and/or B can indicate three situations, only A, A and B, and only B. In addition, a character “/” herein generally indicates that contextual objects are in an “or” relationship.

### Embodiment 1

As shown in FIG. 1, a button battery 10 is provided in this embodiment, which includes a battery cell 20 and a housing assembly with a reinforcing structure for accommodating the battery cell 20.

The housing assembly with the reinforcing structure includes a housing 100, an electrical connection member 13, an insulating member 14, and a reinforcing member 15.

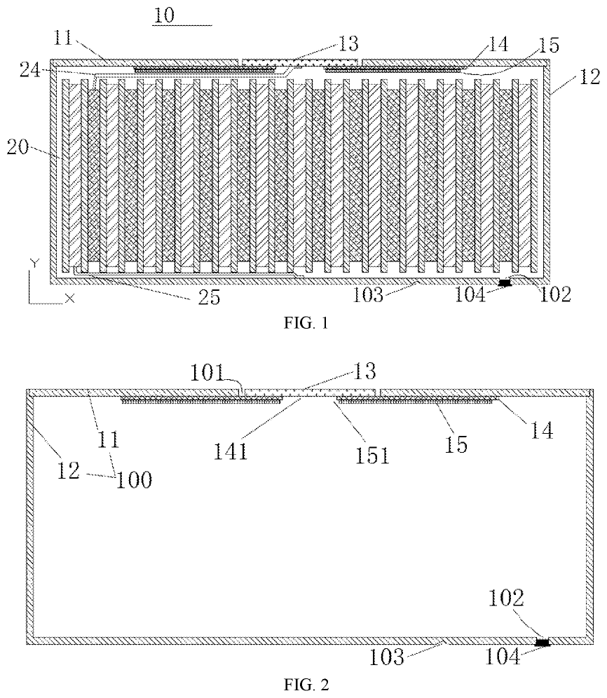

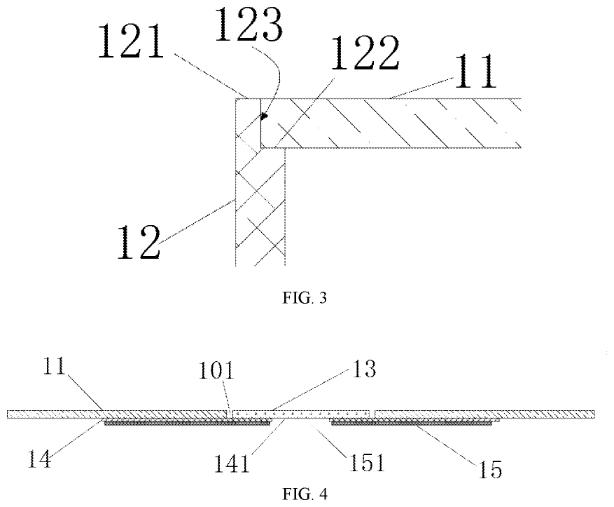

As shown in FIGS. 2 to 4, the housing 100 includes a first housing 11 and a second housing 12. The first housing 11 has a plate-like structure, and the second housing 12 includes a bottom wall and a sidewall arranged at an edge of the bottom wall and extending upwards. The first housing 11 covers an opening of the second housing 12 so as to define a cavity for accommodating the battery cell 20, and the first housing 11 is defined with a through hole 101, through which the cavity is communicated with outside.

Specifically, the second housing 12 is provided with a first protrusion 121 protruding from an opening plane 122, the first protrusion 121 and the opening plane 122 define a positioning groove 123, and the first housing 11 is embedded in the positioning groove 123 and is in interference or clearance fit with the positioning groove 123. By defining the positioning groove 123 at the opening, the first housing 11 and the second housing 12 may avoid to move with respect to each other during welding, and positioning of the first housing 11 and the second housing 12 is also facilitated, thus improving welding efficiency and welding accuracy. Laser welding is adopted for the above welding. The laser welding is fusion welding, by which the first housing 11 and the second housing 12 are melted and welded together at their contact with good sealing strength and sealing performance.

Specifically, an inner surface of the housing 100 is provided with an insulating layer formed by coating an insulating material. The first housing 11 and the second housing 12 may be made of one or more selected from a group consisting of steel alloy, aluminum alloy, iron alloy, copper alloy, nickel alloy, and stainless steel.

Specifically, the housing 100 is also provided with a liquid injection hole 102 and/or an explosion-proof sculpture 103. When the housing at the explosion-proof sculpture 103 is thinned, strength of the battery decreases. When the battery present a safety problem, a large amount of gas may be generated and thus results in a sharp increase in an internal pressure. The pressure may break through the explosion-proof sculpture 103 to discharge the pressure and thus function as a safety valve to prevent the battery from further thermal runaway. The liquid injection hole 102 facilitates injecting of electrolyte, and the liquid injection hole 102 is provided with a sealing plug 104 for closing the liquid injection hole 102. A shape of the explosion-proof sculpture 103 includes, but is not limited to, a semicircle, a crescent, an S-shape, a V-shape, or an X-shape.

The electrical connection member 13 is configured to allow the battery cell 20 placed in the cavity to be electrically connected with outside. A projection of the electrical connection member 13 is located within the through hole 101. A thickness of the electrical connection member 13 in an axial direction Y is less than or equal to a thickness of the first housing 11, and a size of the electrical connection member in a radial direction X is less than a size of the through hole 101. The electrical connection member 13 and the through hole 101 have a concentricity of 100%, and the electrical connection member 13 is accommodated in the through hole 101.

Specifically, the electrical connection member 13 is of a sheet structure, including but not limited to one or more selected from a group consisting of steel alloy, aluminum alloy, iron alloy, copper alloy, nickel alloy, and stainless steel.

The insulating member 14 is arranged in an internal cavity of the first housing 11, and is configured for fixedly connecting the electrical connection member 13 with the first housing 11. The insulating member 14 is defined with a through hole 141, and the through hole 141 and the through hole 101 have a concentricity of 100%. The through hole 141 is fixedly connected with the electrical connection member 13 and the first housing 11 sequentially in its outward emission direction.

Specifically, the insulating member 14 is made of an insulating material, including but not limited to one or more selected from a group consisting of polystyrene (PS), polypropylene (PP), polyethylene (PE), polyester (PET), polyvinyl chloride (PVC), polyimide (PI), acrylonitrile butadiene styrene (ABS), polycarbonate (PC), polyamide (PA), and ceramics. The insulating member 14 may be fixedly connected by, including but not limited to, one or a combination of injection molding, glue bonding, hot pressing compounding, ultrasonic welding, spraying curing, high-temperature curing agent, curing adhesive, high-temperature sintering, and high-frequency heating.

The reinforcing member 15 is partially projected into the through hole 101 and fixedly connected with the first housing 11 through the insulating member 14. Specifically, the reinforcing member 15 is defined with an opening 151, the opening 151 is located within a projection plane of the through hole 101 in the axial direction Y, and has a concentricity of 100% with the second housing 12. The reinforcing member 15 may be of an annular structure made of an alloy material that is subjected to surface insulation treatment, and the reinforcing member 15 may also be an annular structure made of one of ceramic materials, epoxy resin, glass fiber, and mica.

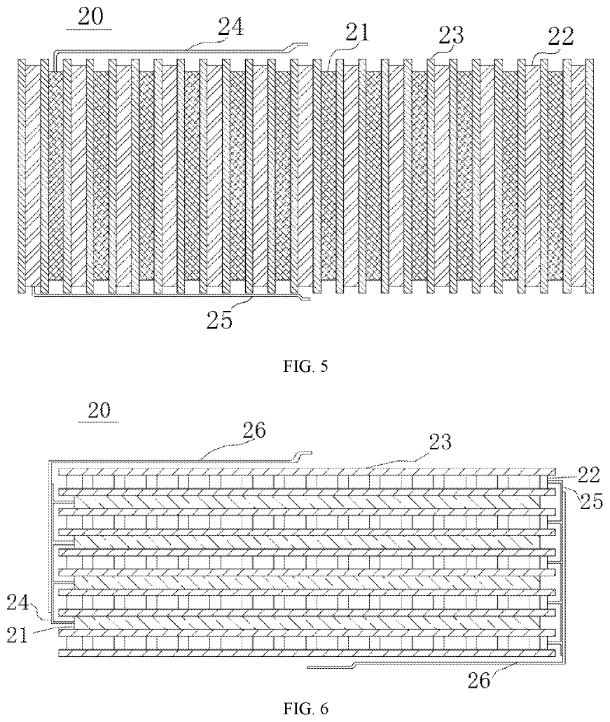

As shown in FIG. 5, the battery cell 20 includes a first electrode plate 21, a second electrode plate 22, a first tab 24, a second tab 25, and a separator 23.

Polarities of the first electrode plate 21 and the second electrode plate 22 are opposite, and polarities of the first tab 24 and the second tab 25 are opposite. The first tab 24 may be obtained by cutting an empty foil of the first electrode plate 21, or may be obtained by welding a metal sheet with same polarity as the first electrode plate 21 on the empty foil of the first electrode plate 21. The second tab 25 may be obtained by cutting an empty foil of the second electrode plate 22, or may be obtained by welding a metal sheet with same polarity as the second electrode plate 22 on the empty foil of the second electrode plate 22. Welding includes but is not limited to resistance welding, ultrasonic welding, and laser welding.

The separator 23 is arranged between the first electrode plate 21 and the second electrode plate 22 to isolate the first electrode plate 21 from the second electrode plate 22 and prevent electrons in the button battery 10 from freely passing through, and to form an ion channel also, to allow ions in the electrolyte to freely pass between the first electrode plate 21 and the second electrode plate 22.

The battery cell 20 may be formed by winding the first electrode plate 21, the second electrode plate 22, and the separator 23, or by laminating the first electrode plate 21, the second electrode plate 22, and the separator 23. The second tab 25 is welded to the bottom wall of the second housing 12, and the first tab 24 is welded to the electrical connection member 13 after the battery cell 20 is placed into the housing. The welding includes resistance welding, ultrasonic welding, and laser welding.

As shown in FIG. 6, the battery cell 20 further includes connectors 26. In case the battery cell 20 includes a plurality of first tabs 24 and a plurality of second tabs 25, one connector 26 is welded with the plurality of first tabs 24 together, and the battery cell 20 is electrically connected with the electrical connection member 13 through the connector 26. Another connector 26 is welded with the plurality of second tabs 25, and the battery cell 20 is electrically connected with the housing 100 through the connector 26. It can be understood that polarities of the two connectors 26 are consistent as those of the welded tabs.

### Embodiment 2

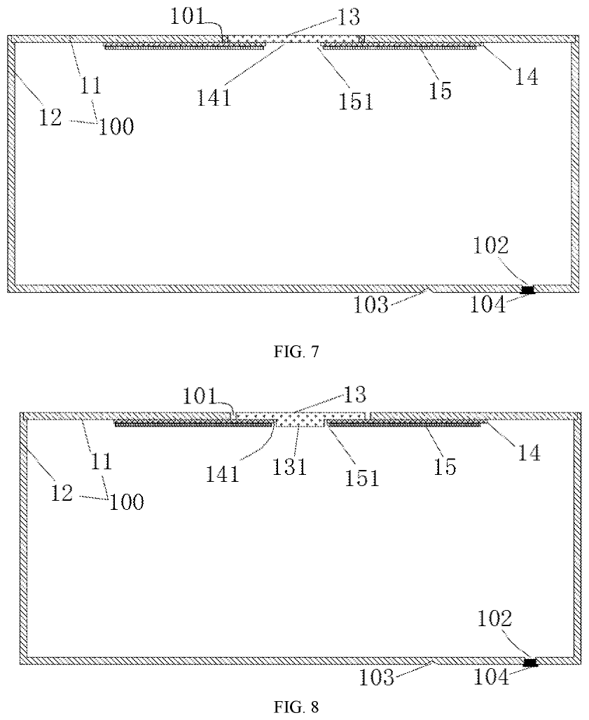

As shown in FIG. 7, unlike Embodiment 1, the electrical connection member 13 of this embodiment is accommodated in the through hole 101 and defines an annular gap cooperatively with the first housing 11, and the annular gap is filled with an insulating material. By filling the annular gap with the insulating material, not only structural strength of the electrical connection member 13 and the first housing 11 is improved, but also sealing between the electrical connection member 13 and the first housing 11 is improved.

Others are the same as Embodiment 1, which will not be repeatedly described here.

### Embodiment 3

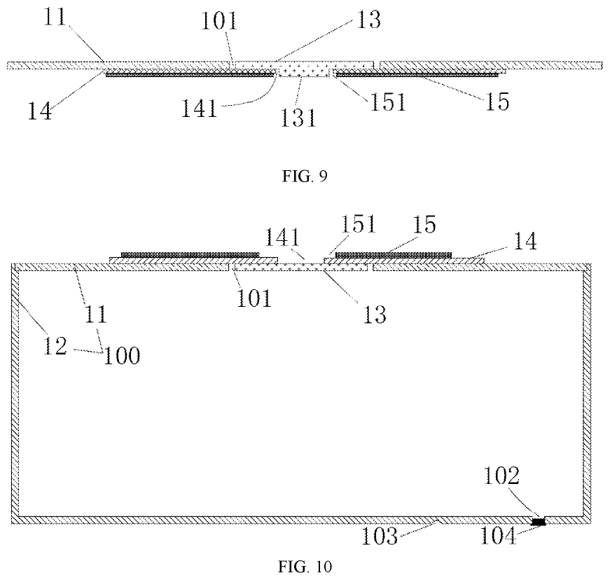

As shown in FIGS. 8 to 9, this embodiment is different from Embodiment 1 in that a protrusion 131 is provided on a metal sheet which is as the electrical connection member 13. The protrusion 131 and the metal sheet may be integrally formed, or the protrusion 131 and the metal sheet are a structure by welding. The protrusion 131 sequentially passes through the through hole 141 of the insulating member 14 and the opening 151 of the reinforcing member 15. In the radial direction X, a size of the protrusion 131 is smaller than that of the opening 151 of the reinforcing member 15; and in the axial direction Y, a thickness of the protrusion 131 is larger than a depth of the opening 151. By providing the protrusion 131 on the electrical connection member 13, structural strength of the electrical connection member 13 is improved.

Others are the same as Embodiment 1, which will not be repeatedly described here.

### Embodiment 4

As shown in FIG. 10, unlike Embodiment 1, the insulating member 14 and the reinforcing member 15 of this embodiment are both arranged outside the housing 100.

Others are the same as Embodiment 1, which will not be repeatedly described here.

### Embodiment 5

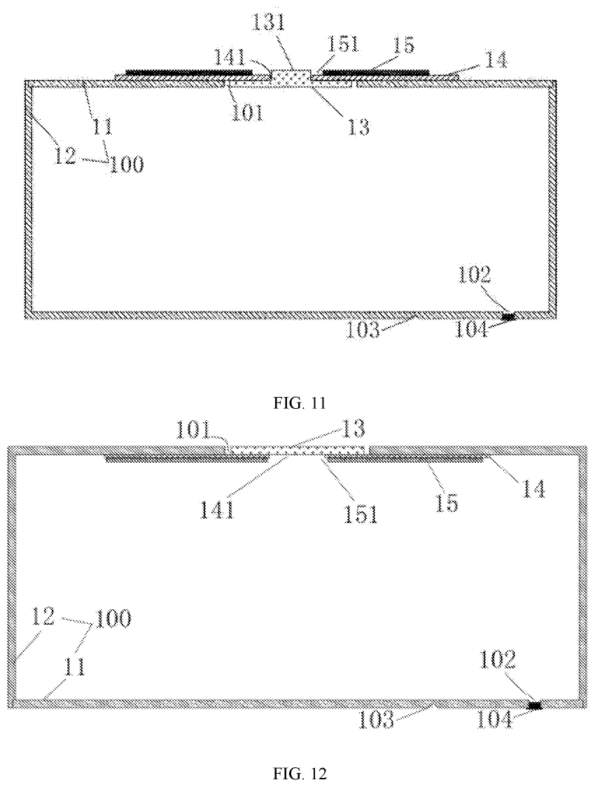

As shown in FIG. 11, this embodiment is different from Embodiment 4 in that the metal sheet which is as the electrical connection member 13 is provided with the protrusion 131. The protrusion 131 and the metal sheet may be integrally formed, or the protrusion 131 and the metal sheet are a structure by welding. The protrusion 131 sequentially passes through the through hole 141 of the insulating member 14 and the opening 151 of the reinforcing member 15. In the radial direction X, a size of the protrusion 131 is smaller than that of the opening 151 of the reinforcing member 15; and in the axial direction Y, a thickness of the protrusion 131 is larger than a depth of the opening 151. By providing the protrusion 131 on the electrical connection member 13, structural strength of the electrical connection member 13 is improved.

Others are the same as Embodiment 4, which will not be repeatedly described here.

### Embodiment 6

As shown in FIG. 12, this embodiment is different from Embodiment 1 in that the through hole 101 is arranged in the second housing 12, the electrical connection member 13 is fixedly connected with the second housing 12 through the insulating member 14, the insulating member 14 is arranged inside the housing 100, and the reinforcing member 15 is fixedly connected with the second housing 12 through the insulating member 14 and is arranged inside the housing 100.

Others are the same as Embodiment 1, which will not be repeatedly described here.

### Embodiment 7

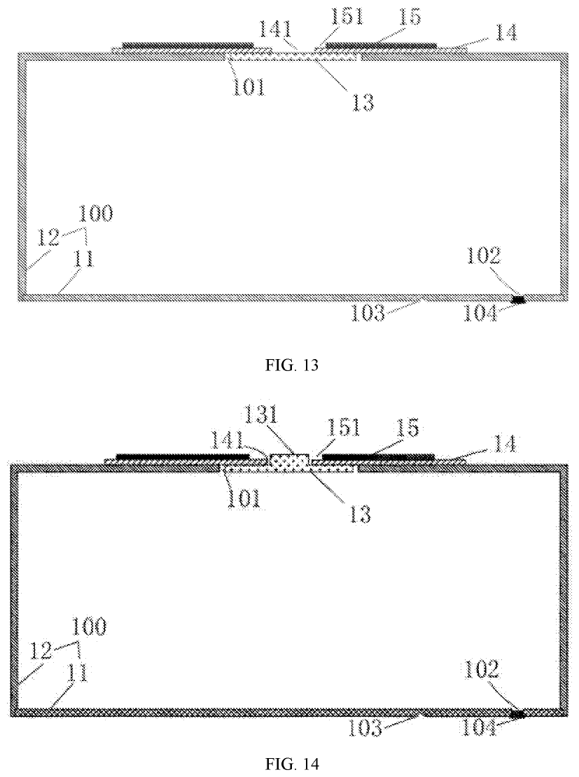

As shown in FIG. 13, this embodiment is different from Embodiment 6 in that the insulating member 14 is arranged outside the housing 100, and the reinforcing member 15 is fixedly connected with the second housing 12 through the insulating member 14 and arranged outside the housing 100.

Others are the same as Embodiment 6, which will not be repeatedly described here.

### Embodiment 8

As shown in FIG. 14, this embodiment is different from Embodiment 7 in that the metal sheet which is as the electrical connection member 13 is provided with the protrusion 131. The protrusion 131 and the metal sheet are integrally formed, or the protrusion 131 and the metal sheet are a welded structure. The protrusion 131 sequentially passes through the through hole 141 of the insulating member 14 and the opening 151 of the reinforcing member 15. In the radial direction X, a size of the protrusion 131 is smaller than that of the opening 151 of the reinforcing member 15; and in the axial direction Y, a thickness of the protrusion 131 is larger than a depth of the opening 151. By providing the protrusion 131 on the electrical connection member 13, structural strength of the electrical connection member 13 is improved.

Others are the same as Embodiment 7, which will not be repeatedly described here.

### Embodiment 9

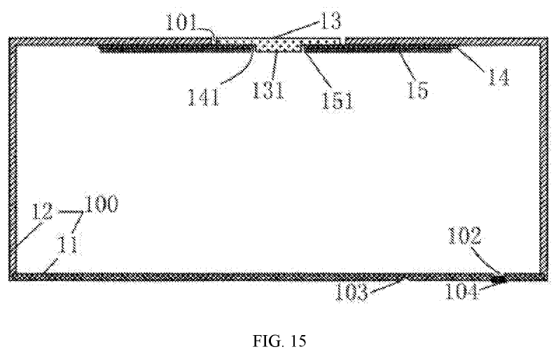

As shown in FIG. 15, this embodiment is different from Embodiment 6 in that the metal sheet which is as the electrical connection member 13 is provided with the protrusion 131. The protrusion 131 and the metal sheet are integrally formed, or the protrusion 131 and the metal sheet are a welded structure. The protrusion 131 sequentially passes through the through hole 141 of the insulating member 14 and the opening 151 of the reinforcing member 15. In the radial direction X, a size of the protrusion 131 is smaller than that of the opening 151 of the reinforcing member 15; and in the axial direction Y, a thickness of the protrusion 131 is larger than a depth of the opening 151. By providing the protrusion 131 on the electrical connection member 13, structural strength of the electrical connection member 13 is improved.

Others are the same as Embodiment 6, which will not be repeatedly described here.

The above is further detailed description of the disclosure in combination with specific preferred embodiments, and it cannot be considered that specific implementation of the disclosure is limited to the description. Several simple deductions or substitutions can be made for ordinary skilled in the art to which this disclosure belongs without departing from the concept of this disclosure, all of which should be regarded as belonging to the protection scope of this disclosure.

What is claimed is:

1. A housing assembly with a reinforcing structure, comprising:
a housing (100) comprising a first housing (11) and a second housing (12), the second housing (12) comprising a bottom wall and a side wall arranged at an edge of the bottom wall and extending upwards, the first housing (11) covering an opening of the second housing (12), the first housing (11) or the second housing (12) being defined with a through hole (101); the second housing (12) being provided with a first protrusion (121) protruding from an opening plane (122), the first protrusion (121) and the opening plane (122) defining a positioning groove (123), and the first housing (11) being embedded in the positioning groove (123);
an electrical connection member (13), a projection of the electrical connection member (13) being located within the through hole (101), the electrical connection member (13) being accommodated in the through hole (101), an annular gap being defined in the through hole (101), and the annular gap being filled with an insulating material;
an insulating member (14) configured for fixedly connecting the electrical connection member (13) with the housing (100), the insulating member (14) being arranged inside or outside the housing (100); and
a reinforcing member (15) partially projected into the through hole (101) and fixedly connected with the housing (100) through the insulating member (14), the reinforcing member (15) being defined with an opening (151), the opening (151) being located in a projection surface of the through hole (101) in an axial direction (Y), and the reinforcing member (15) being of an annular structure made of alloy and subjected to surface insulation treatment.

2. The housing assembly with the reinforcing structure according to claim 1, wherein the electrical connection member (13) is provided with a protrusion (131), a size of the protrusion (131) is smaller than a size of the opening (151) in a radial direction (X), and a thickness of the protrusion (131) is larger than a depth of the opening (151) in the axial direction (Y).

3. The housing assembly with the reinforcing structure according to claim 1, wherein the housing (100) is further provided with a liquid injection hole (102) and/or an explosion-proof sculpture (103).

4. The housing assembly with the reinforcing structure according to claim 1, wherein an inner surface of the housing (100) is provided with an insulating layer.

5. A button battery, comprising a battery cell (20) and a housing assembly with a reinforcing structure for accommodating the battery cell (20), wherein the housing assembly with the reinforcing structure comprises:
a housing (100) comprising a first housing (11) and a second housing (12), the second housing (12) comprising a bottom wall and a side wall arranged at an edge of the bottom wall and extending upwards, the first housing (11) covering an opening of the second housing (12), the first housing (11) or the second housing (12) being defined with a through hole (101); the second housing (12) being provided with a first protrusion (121) protruding from an opening plane (122), the first protrusion (121) and the opening plane (122) defining a positioning groove (123), and the first housing (11) being embedded in the positioning groove (123);
an electrical connection member (13), a projection of the electrical connection member (13) being located within the through hole (101), the electrical connection member (13) being accommodated in the through hole (101), an annular gap being defined in the through hole (101), and the annular gap being filled with an insulating material;
an insulating member (14) configured for fixedly connecting the electrical connection member (13) with the housing (100), the insulating member (14) being arranged inside or outside the housing (100); and
a reinforcing member (15) partially projected into the through hole (101) and fixedly connected with the housing (100) through the insulating member (14), the reinforcing member (15) being defined with an opening (151), the opening (151) being located in a projection surface of the through hole (101) in an axial direction (Y), and the reinforcing member (15) being of an annular structure made of alloy and subjected to surface insulation treatment.

6. The button battery according to claim 5, wherein the electrical connection member (13) is provided with a protrusion (131), a size of the protrusion (131) is smaller than a size of the opening (151) in a radial direction (X), and a thickness of the protrusion (131) is larger than a depth of the opening (151) in the axial direction (Y).

7. The button battery according to claim 5, wherein the housing (100) is further provided with a liquid injection hole (102) and/or an explosion-proof sculpture (103).

8. The button battery according to claim 5, wherein an inner surface of the housing (100) is provided with an insulating layer.
